(19) United States
(12) Patent Application Publication
(10) Pub. No.: US 2017/0074297 A1
(43) Pub. Date: Mar. 16, 2017

(54) LOW NOISE CONTROL ALGORITHM FOR HYDRAULIC SYSTEMS

(71) Applicant: EATON CORPORATION, Cleveland, OH (US)

(72) Inventor: Michael William OLSON, Minneapolis, MN (US)

(21) Appl. No.: 15/309,129

(22) PCT Filed: May 6, 2015
(86) PCT No.: PCT/US2015/029520

§ 371 Date: Nov. 4, 2016

Related U.S. Application Data
(60) Provisional application No. 61/989,215, filed on May 6, 2014.

(51) Int. Cl. F15B 21/00; B66F 9/22; F15B 13/02; F15B 1/04; F15B 11/08

(52) U.S. Cl. CPC F15B 21/008; F15B 1/04; F15B 11/08; F15B 13/022; B66F 9/22; B66F 9/07

(57) ABSTRACT

A hydraulic pump radiant noise reduction method for a forklift or other work machine is disclosed. The method includes initiating a noise control algorithm that is enabled during periods when the displacement of the hydraulic pump remains in the zero displacement position and an operator is not demanding flow from any of the hydraulic branch circuits. When the noise control algorithm is enabled, the control valve assembly associated with the hydraulic branch circuit having the lowest hydraulic fluid pressure in relation to the hydraulic fluid pressures of all other hydraulic branch circuits is opened while the remaining control valve assemblies are in held or placed in a closed position. In an alternative embodiment, a drain valve assembly is provided that is opened when the noise control algorithm is activated.

### CROSS-REFERENCE TO RELATED APPLICATION(S)

This application is being filed on May 6, 2015, as a PCT International Patent application and claims priority to U.S. Patent Application Ser. No. 61/989,215 filed on May 6, 2014, the disclosure of which is incorporated herein by reference in its entirety.

### BACKGROUND

Work machines, such as fork lifts, wheel loaders, track loaders, excavators, backhoes, bull dozers, and telehandlers are known. Work machines can be used to move material, such as pallets, dirt, and/or debris. The work machines typically include a work implement (e.g., a fork) connected to the work machine. The work implements attached to the work machines are typically powered by a hydraulic system. The hydraulic system can include a hydraulic pump that is powered by a prime mover, such as a diesel engine. In some applications, the hydraulic pump alternately powers both the work functions and the driving functions of the work machine. In some operational modes of such systems, excessive or undesirable noise can be generated by the hydraulic pump. Improvements are desired.

### SUMMARY

A hydraulic pump radiant noise reduction method for a forklift or other work machine is disclosed. One step includes providing a hydraulic system having a variable displacement pump in selective fluid communication with a plurality of hydraulic branch circuits, wherein each of the hydraulic branch circuits has a control valve assembly and contains hydraulic fluid at a hydraulic fluid pressure. Another step includes determining that the pump displacement is in a zero displacement position and that an operator is not demanding flow from any of the hydraulic branch circuits. Yet another step includes initiating a noise control algorithm that is enabled as long as the pump displacement remains in the zero displacement position and an operator is not demanding flow from any of the hydraulic branch circuits. When the noise control algorithm is enabled, the method includes the step of opening the control valve assembly associated with the hydraulic branch circuit having the lowest hydraulic fluid pressure in relation to the hydraulic fluid pressures of all other hydraulic branch circuits while ensuring that all remaining control valve assemblies are in a closed position. In some implementations, for example, where a hybrid forklift work machine is provided with a hydraulic pump that powers both the driving and work functions, the valve associated with the lowest pressure function can be the valve that is opened when the noise control algorithm is activated. In an alternative embodiment, a drain valve assembly is provided that is opened when the noise control algorithm is activated while the remaining valves are placed in or remain in the closed position.

### DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a schematic view of a work machine having features that are examples of aspects in accordance with the principles of the present disclosure.

FIG. 2 is a schematic view of a hydraulic system suitable for use in the work machine shown in FIG. 1.

FIG. 3 is a schematic of a modified version of the hydraulic system shown in FIG. 2.

FIG. 4 is a schematic of a modified version of the hydraulic system shown in FIG. 2.

FIG. 5 is a schematic view of an electronic control system for use with the hydraulic systems shown in FIGS. 2, 3, and/or 4.

FIG. 6 is a process flow chart showing a method of operation of the hydraulic system shown in FIGS. 2, 3, and/or 4.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### General Description

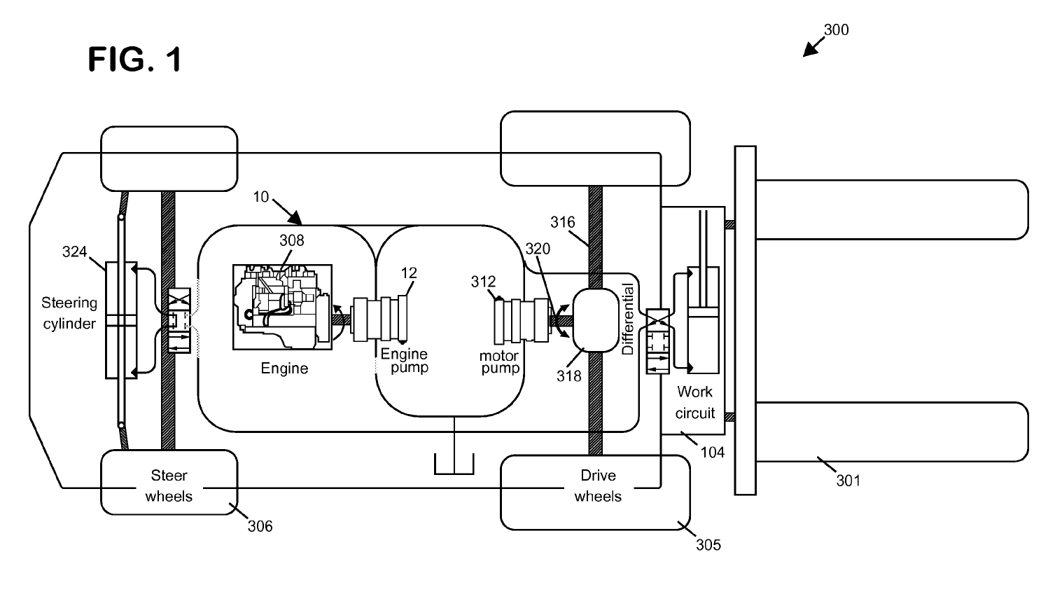

As depicted at FIG. 1, a work machine 300 is shown. Work machine 300 includes a work attachment 301 for performing a variety of work tasks. In one embodiment, work machine 300 is a fork lift truck and work attachment 301 comprises two forks. However, one skilled in the art will appreciate that work attachment may be any hydraulically powered work implement.

Work machine 300 is also shown as including at least one drive wheel 305 and at least one steer wheel 306. In certain embodiments, one or more drive wheels 305 may be combined with one or more steer wheels 306. The drive wheels are powered by an engine 308 in power communication with a pump 12 and a hydraulic motor 312 via a hydraulic propel circuit 204. Pump 12 is mechanically coupled to the engine 308 while hydraulic motor 312 is connected to the engine 308 via a hydraulic system 10. Motor 312 is also mechanically coupled to the drive wheel(s) 305 via axles 316, differential 318, and drive shaft 320.

In one embodiment, a work circuit 104 and a steering circuit 324 are also in fluid communication with the hydraulic system 10. The work circuit 104 actuates the work attachment 301 such that the work tasks can be performed while the steering circuit 324 allows for the work machine 300 to be selectively steered in a desired direction.

### Hydraulic System Description

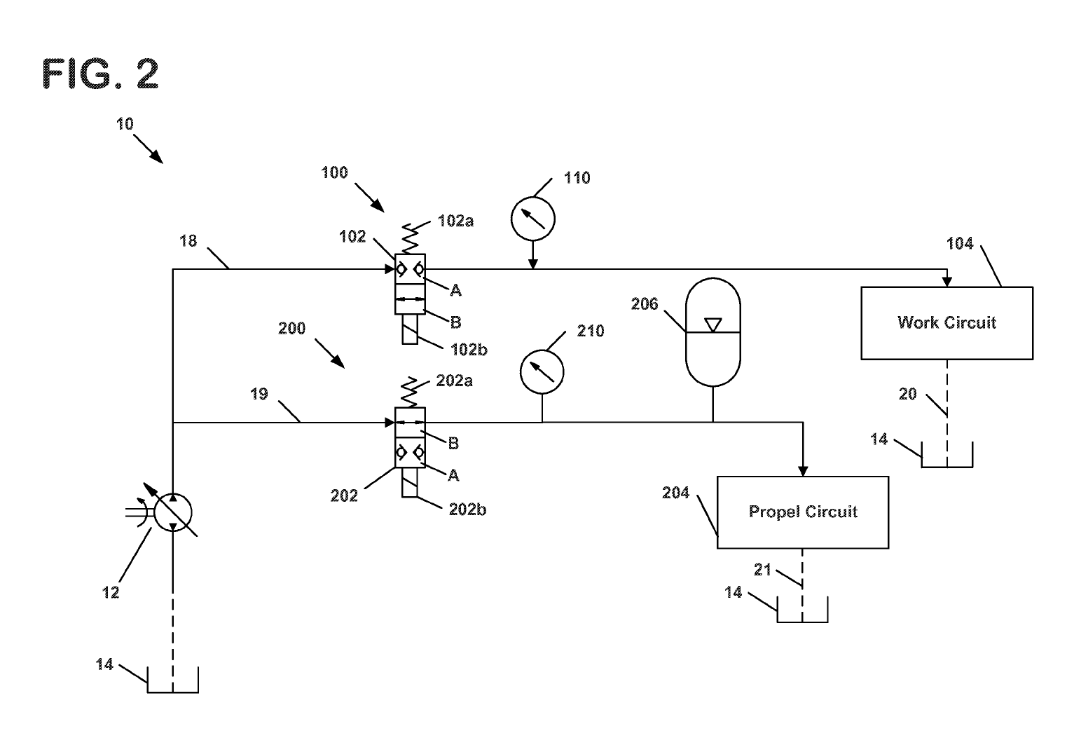

Referring to FIG. 2, a first embodiment of the hydraulic system 10 is illustrated as a schematic diagram. As shown, hydraulic system 10 includes a pump 12 configured to provide pressurized fluid to at least a first hydraulic branch circuit 100 having a first control valve assembly 102 and a second hydraulic branch circuit 200 having a second control valve assembly 202. In the embodiment shown, pump 12 is shown as a variable displacement axial pump. However, other types of pumps may be used for pump 12, such as an over-center pump. As configured, the hydraulic pump 12 includes an inlet (i.e., a low pressure side) that receives hydraulic fluid from a reservoir 14, and the hydraulic pump 12 includes an outlet (i.e., a high pressure side) that is connected to the first and second control valve assemblies 102, 202 via respective hydraulic supply lines 18, 19. When the pump 12 is rotated, hydraulic fluid is drawn from the reservoir 14 into the inlet of the hydraulic pump 12 and expelled from the outlet of the hydraulic pump 12 at a higher pressure.

Still referring to FIG. 2, the control valve assembly 102 is shown as being upstream of the first hydraulic circuit 104 which is configured as a work circuit 104, while the second control valve assembly 202 is shown as being upstream of the second hydraulic circuit 204 which is configured as a propel circuit 204. Fluid is returned from the circuits 104, 204 by a respective reservoir line 20, 21.

The work circuit 104 is provided to control and actuate the various work functions of the work machine via actuators, such as the lift actuator, the tilt actuator, and the side shift actuator for a work attachment (e.g. forks) of a fork lift truck. One example of a work circuit 104 is described in US Patent Application Publication US 2012/0204549 entitled CONDITIONAL LOAD SENSE CONTROL, the entirety of which is hereby incorporated by reference. The work circuit 104 can be configured with one or more valve sections corresponding to one or more individual work circuit sections that are used to actuate various functions of a work machine. The work circuit sections can be configured to activate hydraulic motors and/or hydraulic actuators. For example, the work circuit 104 can include three individual work circuit sections corresponding to lift, tilt, and shift functions of a fork lift.

The propel circuit 204 is provided to power the drivetrain of the work machine. In the embodiment shown, the second hydraulic branch circuit 200 includes an accumulator 206 that functions to store hydraulic fluid at high pressure for use when the pump 12 is unavailable or has insufficient capacity to power the drivetrain. In one embodiment, the propel circuit includes one or more hydraulic motors.

In the embodiment shown at FIG. 1, the first control valve assembly 102 and the second control valve assembly 202 are configured as two-position, two-way valves having a closed position A and open position B. When the first control valve assembly 102 is in the open position B, hydraulic fluid is allowed to pass from the pump 12 to the work circuit 104. Correspondingly, when the first control valve assembly 102 is in the closed position A, fluid is blocked from flowing from the pump 12 to the work circuit 104 and vice versa. When the second control valve 202 is in the open position B, hydraulic fluid is allowed to pass from the pump 12 to the propel circuit 204 and/or the accumulator 206. When the second control valve 202 is in the closed position A, hydraulic fluid is prevented from flowing between the pump and the propel circuit 204 and the accumulator 206. In applications where an accumulator 206 is present in the second hydraulic branch circuit 200 and the pressure at the second hydraulic circuit is greater than the pressure in the first hydraulic branch circuit 100, the closed position A of the second control valve assembly 202 prevents hydraulic fluid from undesirably migrating from the accumulator 206 to the reservoir 14 via the first hydraulic branch circuit 100.

In one embodiment, the first control valve assembly 102 is provided with a biasing spring 102a and an actuator 102b. As shown, the biasing spring 102a functions to bias the first control valve assembly 102 to the closed position A while the actuator 102b functions to drive the first control valve assembly 102 to the open position B against the force of the biasing spring 102a. However, it is noted that the biasing and control functions could be oppositely arranged, if desired, such that the valve 102 is biased to the open position B and actuated to the closed position A. In one embodiment, the first control valve assembly 102 is a spool type valve in which the biasing spring 102a and the actuator 102b act on opposite ends of a spool within a sleeve. In the embodiment shown, the actuator 102b is a variable force solenoid valve (i.e. a proportional control valve) or voice coil. However, it is to be understood that the actuator 102b could be a hydraulic actuator or another type of electric or electro-hydraulic actuator.

In one embodiment, the second control valve assembly 202 is provided with a biasing spring 202a and an actuator 202b. As shown, the biasing spring 202a functions to bias the second control valve assembly 202 to the open position B while the actuator 102b functions to drive the second control valve assembly 202 to the closed position A against the force of the biasing spring 202a. However, it is noted that the biasing and control functions could be oppositely arranged, if desired, such that the valve 202 is biased to the closed position and actuated to the open position. In one embodiment, the second control valve assembly 202 is a spool type valve in which the biasing spring 202a and the actuator 202b act on opposite ends of a spool within a sleeve. In the embodiment shown, the actuator 202b is a variable force solenoid valve (i.e. a proportional control valve) or voice coil. However, it is to be understood that the actuator 202b could be a hydraulic actuator or another type of electric or electro-hydraulic actuator.

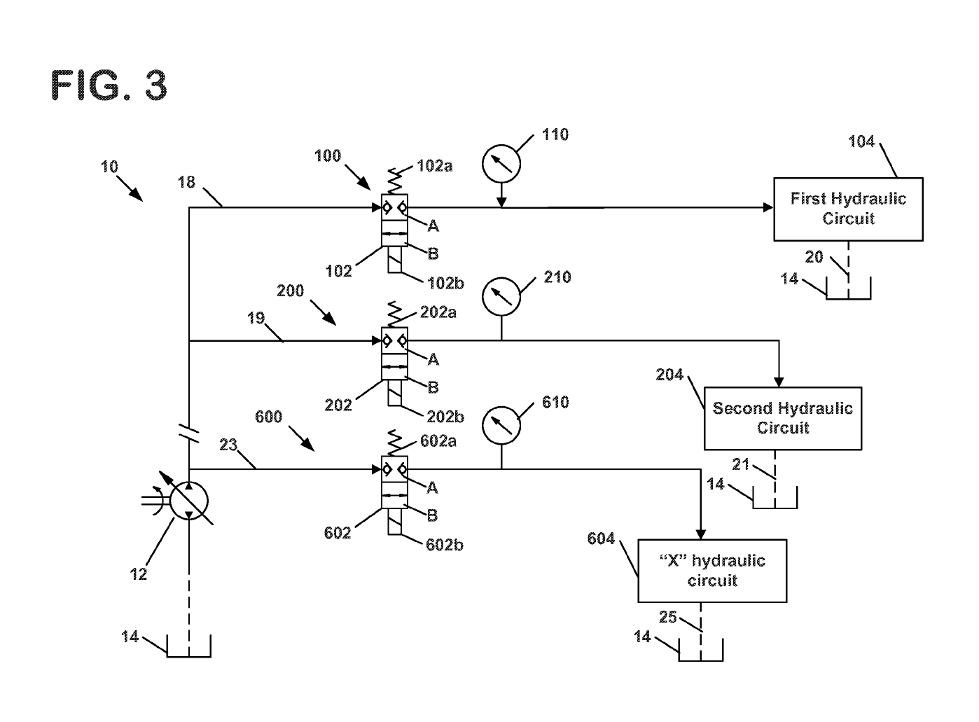

As shown in FIG. 3, the hydraulic system 10 may include any number (“x”) of desired hydraulic circuits, as represented by hydraulic circuit 604, for example up to twenty hydraulic circuits. In one embodiment, one of the additional hydraulic circuits 604 can be the steering circuit 324 of the work machine 300. Hydraulic circuit 604 may be provided with a control valve assembly 602 and a pressure sensor 610 that are similar to those described in relation to those shown for the first and second branch circuits 100, 200 at FIG. 1. For example, control valve assembly 602 may include an actuator 602b and a biasing spring 602a to move the valve assembly between a closed position A and an open position B. The hydraulic circuit(s) 604 may also be placed in fluid communication with the pump 12 via a supply line 23 and placed in fluid communication with the reservoir 14 via drain line 25. It is noted that the schematic shown at FIG. 3 shows the second hydraulic circuit 204 without the use of the accumulator 206 and that the control valve assemblies 102, 202, 602 are biased to the closed position A by their respective biasing springs 102a, 202a, 602a.

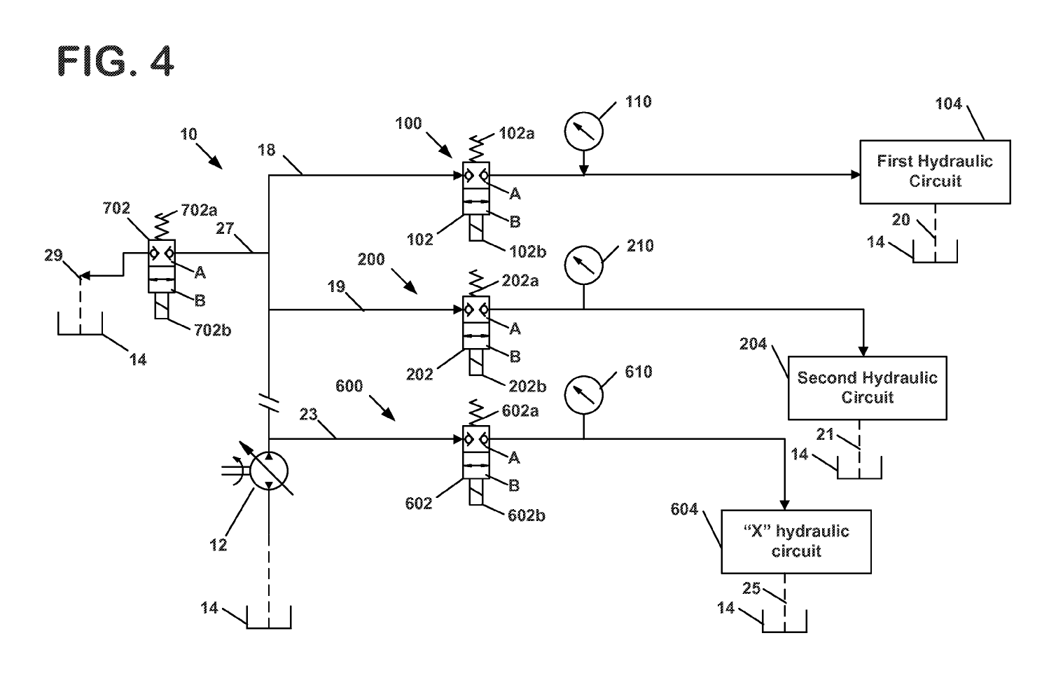

With reference to FIG. 4, the hydraulic system 10 may further include a dedicated drain valve assembly 702. As shown, the drain valve assembly 702 is configured as a two-position, two-way valve having a closed position A and and open position B. When the drain valve assembly 702 is in the open position B, hydraulic fluid is allowed to pass directly from the pump 12 to the reservoir 14. Correspondingly, when the drain valve assembly 702 is in the closed position A, fluid is blocked from flowing from the pump 12 to the reservoir via the drain valve assembly 702.

In one embodiment, the drain valve assembly 702 is provided with a biasing spring 702a and an actuator 702b. As shown, the biasing spring 702a functions to bias the drain valve assembly 702 to the closed position A while the actuator 702b functions to drive the drain valve assembly 702 to the open position B against the force of the biasing spring 702a. However, it is noted that the biasing and control functions could be oppositely arranged, if desired, such that the valve 702 is biased to the open position B and actuated to the closed position A. In one embodiment, the drain valve assembly 702 is a spool type valve in which the biasing spring 702a and the actuator 702b act on opposite ends of a spool within a sleeve. In the embodiment shown, the actuator 702b is a variable force solenoid valve (i.e. a proportional control valve) or voice coil. However, it is to be understood that the actuator 702b could be a hydraulic actuator or another type of electric or electro-hydraulic actuator.

### The Electronic Control System

The hydraulic system 10 operates in various modes depending on demands placed on the work machine 300 (e.g., by an operator). The electronic control system monitors and allows for the various modes to be initiated at appropriate times. An electronic controller 50 monitors various sensors and operating parameters of the hydraulic system 10 to configure the hydraulic system 10 into the most appropriate mode of operation.

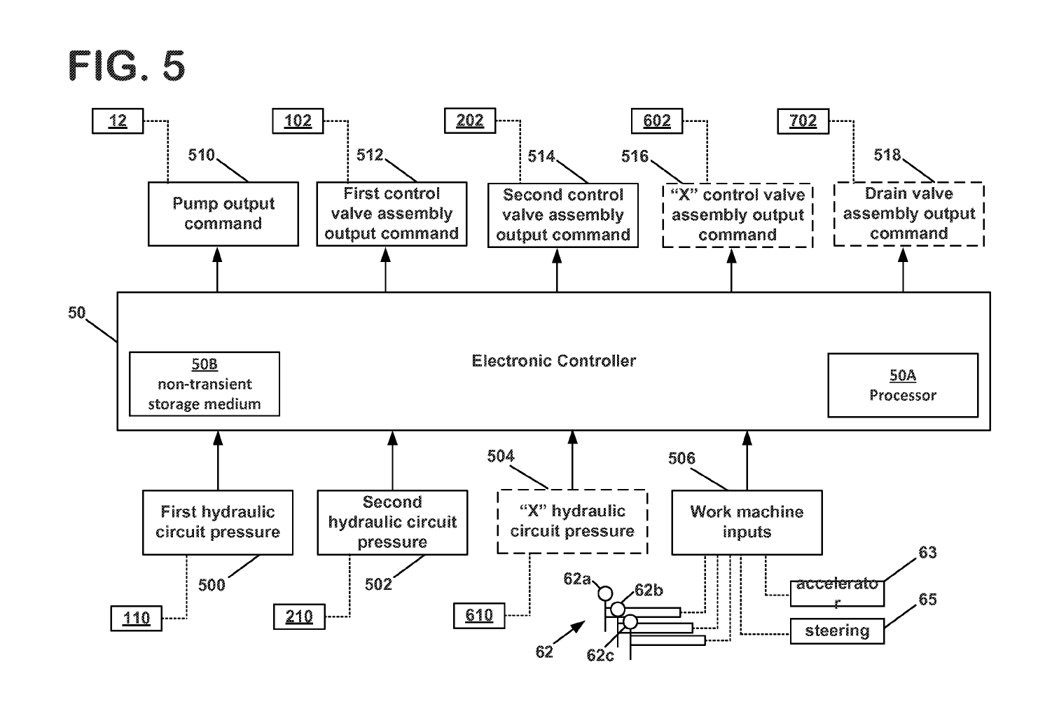

Referring to FIG. 5, the electronic controller 50 is schematically shown as including a processor 50A and a non-transient storage medium or memory 50B, such as RAM, flash drive or a hard drive. Memory 50B is for storing executable code, the operating parameters, the input from the operator interface while processor 50A is for executing the code. Electronic controller 50 is also shown as having a number of inputs and outputs that may be used for implementing the work circuit operational modes. As shown, the electronic controller 50 includes a first hydraulic circuit pressure input 500, a second hydraulic circuit pressure input 502, and up to “X” hydraulic circuit pressure inputs 504. Electronic controller is also shown as having a plurality of work machine inputs 506 which may include: one or more levers 62 such as a lift lever 62a, a tilt lever 62b, and a side shift lever 62c; an accelerator pedal position 63; and a steering wheel position 65. In one embodiment, the lever position input(s) is a direct digital signal from an electronic lever. The work lever 62 provides a user indication to the controller 50 that a work operation by hydraulic actuator(s) associated with the work circuit 104 is desired. One skilled in the art will understand that many other inputs are possible. For example, measured engine speed may be provide as a direct input into the electronic controller 50 or may be received from another portion of the control system via a control area network (CAN). The measured pump displacement, for example via a displacement feedback sensor, may also be provided. In one embodiment, the electronic controller 50 is configured to include all required operational inputs for the various circuits 104, 204, 604.

Still referring to FIG. 5, a number of outputs from the electronic controller 50 are shown. One output is a pump output command 510 which is for adjusting the output pressure of the pump 12. In one embodiment, pump pressure output can be controlled by adjusting the angle of the swash plate in a variable displacement axial piston pump. Additional outputs shown are the first control valve assembly position command 512; the second control valve assembly position command 514; the “X” control valve assembly position command 516; and the drain valve assembly position command 518. Other outputs are possible as well. In one embodiment, the electronic controller 50 is configured to include all required operational outputs for the various circuits 104, 204, 604.

The electronic controller 50 may also include a number of maps or algorithms to correlate the inputs and outputs of the controller 50. For example, the controller 50 may include an algorithm to control the position of the valves 102, 202, 602, and/or 702 based on predicted noise output levels and measured pressures at sensors 110, 210, and/or 610, as described further in the Method of Operation section below.

The electronic controller 50 may also store a number of predefined and/or configurable parameters and offsets for determining when each of the modes is to be initiated and/or terminated. As used herein, the term “configurable” refers to a parameter or offset value that can either be selected in the controller (i.e. via a dipswitch) or that can be adjusted within the controller.

### Method of Operation

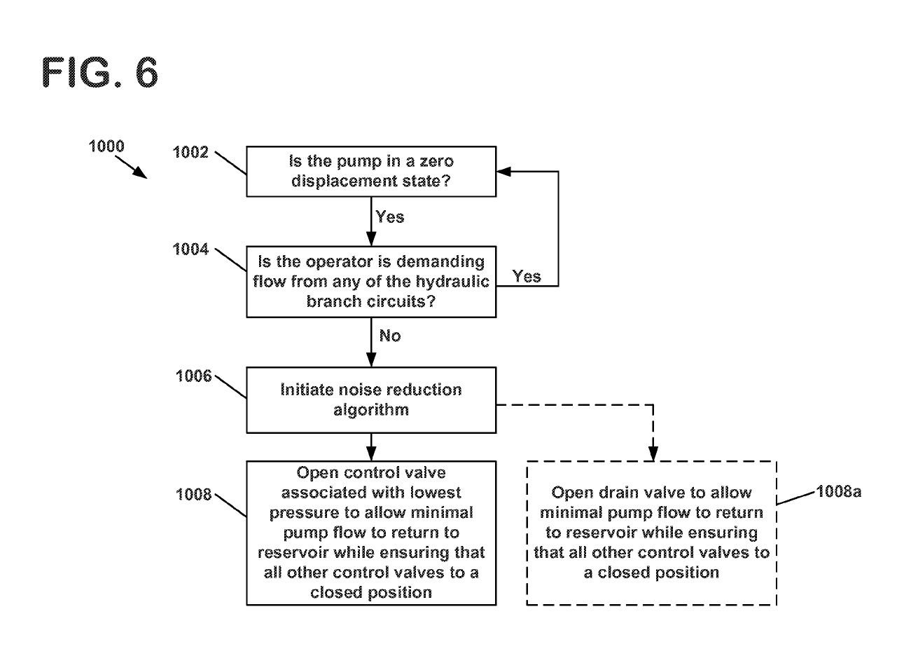

Referring to FIG. 6, method 1000 for operating the control valve assemblies 102, 202, 602, and/or 702 is shown. It is noted that although FIG. 6 diagrammatically shows the method steps in a particular order, the methods are not necessarily intended to be limited to being performed in the shown order. Rather at least some of the shown steps may be performed in an overlapping manner, in a different order and/or simultaneously.

In a first step 1002 of the method 1000, the electronic controller 50 determines that the hydraulic pump 12 is in a zero displacement state, meaning that the pump 12 has either been commanded to produce no output flow or that the various control valves are at zero flow and/or are in a closed position because the operator is not requesting an operation. It is noted that in actual implementations of a hydraulic system utilizing a variable displacement axial piston pump, a completely or true zero flow state at the pump 12 does not occur and that some flow is produced by the pump in this condition. Therefore, the terms “zero output position” and “zero displacement position” include those positions of the hydraulic pump that are near to no displacement or flow but where a slight positive hydraulic flow is still generated by the pump 12. Because of this circumstance, and because no relief valves are shown as being provided in the hydraulic system 10, at least one of the control valves 102, 202, 602, and/or 702 must be commanded at least partially open to allow the minimal flow from the pump 12 to flow back to the reservoir 14.

At a step 1004, a determination is made as to whether the operator is demanding flow from any of the hydraulic branch circuits 100, 200, 600. In one embodiment, this determination can be made based on the above described inputs 506 to the electronic controller 50 wherein the inputs indicate that no function at the hydraulic circuit 104, 204, 604 of the work machine 300 is being requested. If flow is being demanded from any of the branch circuits 100, 200, 600, then the method returns to step 1002.

At a step 1006, a low noise control or noise reduction algorithm is initiated within the controller 50. The noise reduction algorithm will remain active as long as the pump 12 remains in a zero displacement state and no demand from the operator is detected. The noise reduction algorithm is for reducing noise at the pump 12 caused by high pressure differential between the hydraulic branch circuits and the inlet side of the pump 12. It is noted that radiant noise generated by the pump 12 increases as the differential pressure across the inlet and outlet of the pump 12 increases. Accordingly, when the pump 12 is exposed to a branch circuit at a relatively high pressure, the noise output of the pump will be greater than the noise produced when the pump 12 is exposed to a branch circuit at a relatively lower pressure.

At a step 1008, the control valve associated with the lowest branch line pressure is opened to allow the minimal pump flow to return to the reservoir while ensuring that all remaining control valves for branch circuits served by the pump are in a closed position. The closed position can be accomplished by actuating the valve assembly or assemblies to the closed position or by providing a valve that is biased to the closed position. In one embodiment, the lowest branch line pressure can be determined by comparing the inputs from the pressure sensors 110, 210, and/or 610. As stated above, opening the control valve associated with the lowest pressure will result in the lowest noise generation at the pump 12. For the particular configuration shown in FIG. 2, which includes an accumulator 206 to maintain a high pressure, the first hydraulic branch circuit 100 would normally be expected to be at a lower pressure than the second hydraulic branch circuit 200. As such, the first control valve assembly 102 may be chosen as a default valve assembly to open once the noise reduction control algorithm is implemented instead of or in addition to performing a direct comparison of branch circuit pressures. For the particular configuration shown in FIG. 3, which includes an additional drain valve assembly 702, an alternate step 1008a may be implemented rather than step 1008. In step 1008a, the drain valve assembly 702 is opened to allow the minimal pump flow to return to reservoir once the noise reduction algorithm has been implemented at step 1006, wherein the valve assemblies associated with the hydraulic branch circuits are commanded to the closed position or left in the default closed position.

The above described method can result in a substantial reduction in the radiant sound output from the hydraulic pump, as compared to typical hydraulic systems which do not implement any type of noise reduction control strategy.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A hydraulic pump radiant noise reduction method including the steps of:
(a) providing a hydraulic system having a variable displacement pump in selective fluid communication with a plurality of hydraulic branch circuits, each of the hydraulic branch circuits having a control valve assembly and containing hydraulic fluid at a hydraulic fluid pressure;
(b) determining that the pump displacement is in a zero displacement position and that an operator is not demanding flow from any of the hydraulic branch circuits;
(c) initiating a noise control algorithm that is enabled as long as the pump displacement remains in the zero displacement position and an operator is not demanding flow from any of the hydraulic branch circuits; and
(d) the noise control algorithm including, opening the control valve assembly associated with the hydraulic branch circuit having the lowest hydraulic fluid pressure in relation to the hydraulic fluid pressures of all other hydraulic branch circuits while ensuring that all remaining control valve assemblies are in a closed position.

2. The hydraulic pump radiant noise reduction method of claim 1, wherein the step of opening the control valve assembly associated with the hydraulic branch circuit having the lowest hydraulic fluid pressure includes opening a control valve assembly that is predetermined as having the lowest hydraulic fluid pressure.

3. The hydraulic pump radiant noise reduction method of claim 1, wherein the step of opening the control valve assembly associated with the hydraulic branch circuit having the lowest hydraulic fluid pressure includes comparing the hydraulic pressures at each branch circuit.

4. The hydraulic pump radiant noise reduction method of claim 1, wherein the step of providing a hydraulic system includes providing a pressure sensor for each of the plurality of hydraulic branch circuits.

5. The hydraulic pump radiant noise reduction method of claim 1, wherein the step of providing a hydraulic system includes providing a first branch circuit and a second branch circuit, wherein the second branch circuit includes an accumulator.

6. The hydraulic pump radiant noise reduction method of claim 5, wherein the step of providing a hydraulic system includes providing a first control valve assembly for the first branch circuit and providing a second control valve assembly for the second branch circuit, wherein the first control valve assembly is biased to a closed position and wherein the second control valve assembly is biased to an open position.

7. The hydraulic pump radiant noise reduction method of claim 6, wherein the step of opening the control valve assembly associated with the hydraulic branch circuit having the lowest hydraulic fluid pressure includes opening the first control valve assembly.

8. The hydraulic pump radiant noise reduction method of claim 4, wherein the step of providing a hydraulic system includes providing a first branch circuit, a second branch circuit, and a third branch circuit.

9. The hydraulic pump radiant noise reduction method of claim 5, wherein the step of providing a hydraulic system includes providing a first control valve assembly for the first branch circuit, providing a second control valve assembly for the second branch circuit, and providing a third control valve assembly for a third branch circuit, wherein the first, second, and third control valve assemblies are biased to a closed position.

10. A hydraulic pump radiant noise reduction method including the steps of:
(a) providing a hydraulic system having a variable displacement pump in selective fluid communication with a plurality of hydraulic branch circuits, each of the hydraulic branch circuits having a control valve assembly and containing hydraulic fluid at a hydraulic fluid pressure;
(b) providing a drain valve assembly positioned and arranged to selectively place the variable displacement pump in fluid communication with a hydraulic fluid reservoir;
(c) determining that the pump displacement is in a zero displacement position and that an operator is not demanding flow from any of the hydraulic branch circuits;
(d) initiating a noise control algorithm that is enabled as long as the pump displacement remains in the zero displacement position and an operator is not demanding flow from any of the hydraulic branch circuits; and
(e) the noise reduction algorithm including, opening the drain valve assembly while ensuring that the control valve assemblies associated with the hydraulic branch circuits are in the closed position.

11. The hydraulic pump radiant noise reduction method of claim 10, wherein the step of providing a hydraulic system includes providing a first control valve assembly for a first branch circuit and providing a second control valve assembly for a second branch circuit, wherein the first and second control valve assemblies are biased to a closed position.

12. The hydraulic pump radiant noise reduction method of claim 11, wherein the step of providing a hydraulic system includes providing a third control valve assembly for a third branch circuit, wherein the third valve assembly is biased to a closed position.

13. A forklift hydraulic pump radiant noise reduction method including the steps of:
(a) providing a forklift having a hydraulic system having a variable output pump in selective fluid communication with:
i. a first hydraulic branch circuit including a first control valve assembly and a work circuit for powering at least lifting and tilt functions of the forklift; and
ii. a second hydraulic branch circuit including a second control valve assembly, an accumulator, and a propel circuit for powering driving functions of the forklift; and
(b) determining that the pump output is in a near zero flow state and that an operator is not demanding flow from any of the hydraulic branch circuits;
(c) initiating a noise control algorithm that is enabled as long as the pump displacement remains in the zero displacement position and the operator is not demanding flow from any of the hydraulic branch circuits; and
(d) the noise control algorithm including, opening the first control valve to allow minimal pump flow from the pump to return to a reservoir while ensuring that the second control valve assembly is in a closed position.

14. The forklift hydraulic pump radiant noise reduction method of claim 13, wherein the step of providing a forklift having a hydraulic system includes the first control valve assembly being biased to a closed position and the second control valve assembly being biased to an open position.

15. The forklift hydraulic pump radiant noise reduction method of claim 14, wherein the first and second control valve assemblies each include a biasing spring and an actuator.

16. The forklift hydraulic pump radiant noise reduction method of claim 15, wherein each actuator of the first and second control valves is a solenoid type control valve.

17. The forklift hydraulic pump radiant noise reduction method of claim 13, further including the step of:
(a) providing an electronic controller in communication with the first and second control valve assemblies, the electronic controller being configured to execute the noise control algorithm.

18. The forklift hydraulic pump radiant noise reduction method of claim 17, wherein the step of providing an electronic controller includes providing an electronic controller that further receives operator inputs relating to the work circuit and the propel circuit.

19. The forklift hydraulic pump radiant noise reduction method of claim 18, wherein the step of providing an electronic controller that receives operator inputs relating to the work circuit and the propel circuit includes receiving inputs from a lift lever, a tilt lever, and a side shift lever.

20. The forklift hydraulic pump radiant noise reduction method of claim 13, wherein the step of providing a variable output pump includes providing a variable displacement axial piston pump having a swash plate.
